(19) United States
(12) Patent Application Publication
(10) Pub. No.: US 2014/0229496 A1
(43) Pub. Date: Aug. 14, 2014

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Keisuke MINAMI, Kawasaki-shi (JP); Daisuke AJITOMI, Tokyo (JP); Masataka GOTO, Yokohama-shi (JP); Shinya MURAI, Kawasaki-shi (JP)

(73) Assignee: KABUSHIKI KAISHA TOSHIBA, Tokyo (JP)

(21) Appl. No.: 14/173,940

(22) Filed: Feb. 6, 2014

(30) Foreign Application Priority Data
Feb. 8, 2013 (JP) 2013-023834

(51) Int. Cl. G06F 17/30

(52) U.S. Cl. CPC G06F 17/30289
USPC 707/756

(57) ABSTRACT

According to an embodiment, an information processing device includes a first memory unit, a second memory unit, and a transformation processing unit. The first memory unit is configured to store therein data having a graph structure which contains, as node information of a node, a list of edges related to the node. The second memory unit is configured to store therein data which has a non-graph structure different from the graph structure and which represents a mutual relationship between data elements. The transformation processing unit is configured to transform a data structure of the data stored in the first memory unit from the graph structure to the non-graph structure, and store the transformed data in the second memory unit.

### CROSS-REFERENCE TO RELATED APPLICATION(S)

This application is based upon and claims the benefit of priority from Japanese Patent Application No. 2013-023834, filed on Feb. 8, 2013; the entire contents of which are incorporated herein by reference.

### FIELD

Embodiments described herein relate generally to an information processing device, an information processing method, and a computer program product.

### BACKGROUND

Typically, graph databases are known that enable expressing data which is difficult to efficiently express using relational databases. Moreover, various graph database techniques are being studied with the aim of enabling high-speed searching.

However, graph databases have a problem as follows. There are times when a node has an excessive number of edges; thus, depending on the data that is stored, the processing load sometimes increases to a considerable extent thereby leading to a decline in the processing speed.

### BRIEF DESCRIPTION OF THE DRAWINGS

FIG. 1 is a block diagram illustrating an exemplary configuration of an information processing device according to an embodiment;

FIG. 2 is a flowchart for explaining an example of operations performed in the information processing device according to the embodiment;

FIG. 3 is a diagram illustrating exemplary data that has a graph structure and that is stored in a first memory unit, and illustrating an example of a non-graph structure of data stored in a second memory unit;

FIG. 4 is a diagram illustrating a first example of optimization performed by a structure transforming unit with respect to the data having the graph structure illustrated in FIG. 3;

FIG. 5 is a diagram illustrating a second example of optimization performed by the structure transforming unit with respect to the data having the graph structure illustrated in FIG. 3;

FIG. 6 is a diagram illustrating a third example of optimization performed by the structure transforming unit with respect to the data having the graph structure illustrated in FIG. 3;

FIG. 7 is a flowchart for explaining an example of operations performed to process a query in the information processing device according to the embodiment;

FIG. 8 is a diagram illustrating the data of the graph structure stored in the first memory unit (in the case when an opposite node is not a leaf node) according to the embodiment; and

FIG. 9 is a diagram illustrating a third exemplary operation implemented in the information processing device according to the embodiment in the case when an opposite node is not a leaf node.

### DETAILED DESCRIPTION

According to an embodiment, an information processing device includes a first memory unit, a second memory unit, and a transformation processing unit. The first memory unit is configured to store therein data having a graph structure which contains, as node information of a node, a list of edges related to the node. The second memory unit is configured to store therein data which has a non-graph structure different from the graph structure and which represents a mutual relationship between data elements. The transformation processing unit is configured to transform a data structure of the data stored in the first memory unit from the graph structure to the non-graph structure, and store the transformed data in the second memory unit.

An information processing device according to an embodiment is described below with reference to the accompanying drawings.

### Embodiment

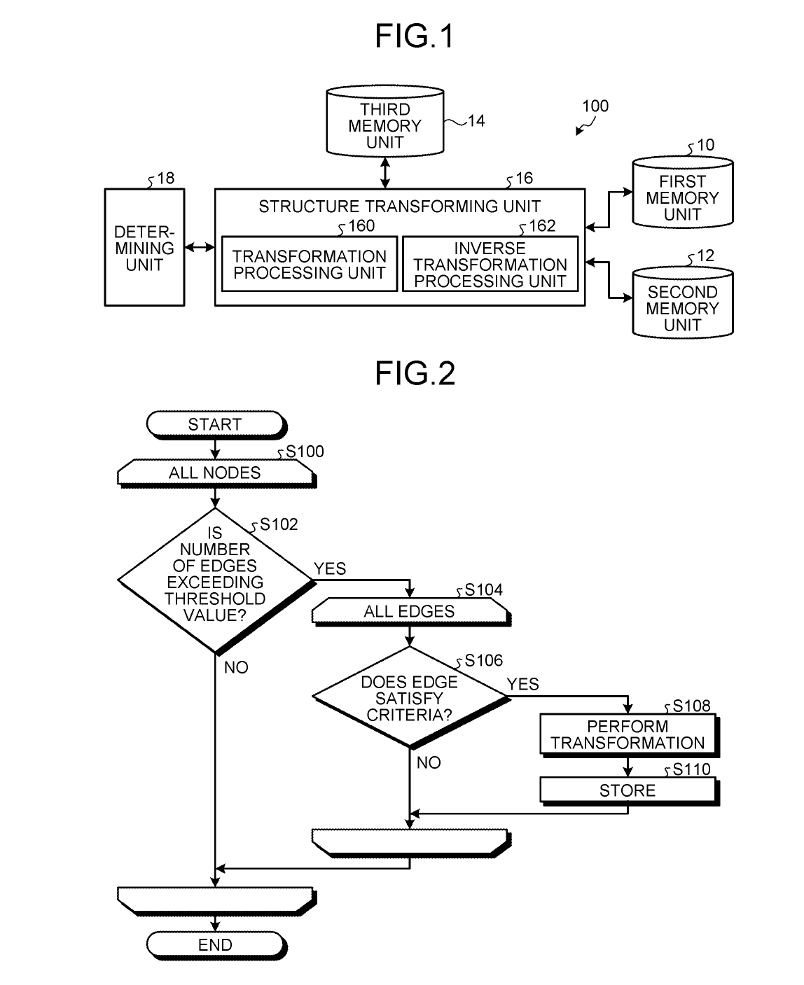

FIG. 1 is a block diagram illustrating an exemplary configuration of an information processing device 100 according to the embodiment. Herein, the information processing device 100 is configured with, for example, a general-purpose computer. That is, the information processing device 100 has the functions of a computer that includes a central processing unit (CPU), a memory device, and a communication interface.

As illustrated in FIG. 1, the information processing device 100 includes a first memory unit 10, a second memory unit 12, a third memory unit 14, a structure transforming unit 16, and a determining unit 18. The first memory unit 10, the second memory unit 12, as well as the third memory unit 14 is configured with, for example, a single or a plurality of hard disk drives (HDDs). The structure transforming unit 16 and the determining unit 18 can be implemented either with a hardware circuit or with software executed in the CPU.

The first memory unit 10 is used to store therein data having a graph structure which contains, as node information of a node, a list of edges related to the node. For example, the first memory unit 10 is used to store therein the data of a graph structure and thus configures a graph database.

The second memory unit 12 is used to store therein data that has a non-graph structure different from the graph structure and that represents the mutual relationship between data elements. For example, the second memory unit 12 is used to store therein data having a property structure composed mainly of keys and values. More particularly, the second memory unit 12 is used to store therein the properties of nodes in a graph database, and configures a key value store (KVS), a column-oriented database, or a relational database management system (RDBMS).

The structure transforming unit 16 includes a transformation processing unit 160 and an inverse transformation processing unit 162. Moreover, the structure transforming unit 16 accesses the first memory unit 10 and the second memory unit 12, and stores transformation processing information (described later) in the third memory unit 14. Furthermore, based on the determination result of the determining unit 18 (described later), the transformation processing unit 160 transforms the data structure of the data stored in the first memory unit 10 from the graph structure to the non-graph structure, and stores the transformed data in the second memory unit 12. Similarly, based on the determination result of the determining unit 18 (described later), the inverse transformation processing unit 162 transforms the data structure of the data stored in the second memory unit 12 from the non-graph structure to the graph structure, and stores the transformed data in the first memory unit 10.

The determining unit 18 obtains the data stored in the first memory unit 10 or the second memory unit 12 via, for example, the structure transforming unit 16 and determines, based on predetermined determination criteria, whether the obtained data should be stored in the graph structure or in the non-graph structure. Herein, the determining unit 18 performs the determination using at least any one of the following predetermined determination criteria: the number of edges related to a node; the access frequency with respect to an edge of the node; the calculation amount for searching an edge of the node; the elapsed time since the last access to an edge of the node; whether or not another node linked to an edge of the node is a leaf node; and the criteria of BDD (Binary Decision Diagram) or ZDD (Zero-suppressed Binary Decision Diagram). That is to say, the determining unit 18 determines the most suitable data structure for the data stored in the first memory unit 10 or the second memory unit 12.

Meanwhile, the determining unit 18 may be configured to perform the determination in at least one of the cases given below. For example, every time the data stored in the first memory unit 10 is updated, the determining unit 18 performs the determination based on predetermined determination criteria. Alternatively, the determining unit 18 performs the determination when instruction information indicating an instruction to start the determination is received, or performs the determination at predetermined intervals. Still alternatively, the determining unit 18 performs the determination after a read query is executed with respect to the data stored in the first memory unit 10.

Then, based on the determination result of the determining unit 18 about the most suitable data structure, the structure transforming unit 16 performs data structure transformation. The third memory unit 14 is used to store therein transformation processing information, which is the information (history) on the result of data structure transformation and the result of transformed-data storing performed by the structure transforming unit 16. For example, if the transformation processing unit 160 transforms the data structure of the data stored in the first memory unit 10 from the graph structure to the non-graph structure and stores the transformed data in the second memory unit 12; then the structure transforming unit 16 stores transformation processing information, which at least indicates those operations, in the third memory unit 14.

As described above, the data stored in the first memory unit 10 has the graph structure that enables high-speed searching of a node which is linked to a particular node via an edge. More particularly, a list of edges related to a particular node is held as node information of the node, and each edge contains a pointer to the node information of an opposite node (which is another node linked to that edge). Therefore, in order to move from node to node by tracking the edges, it is sufficient to follow the pointers included in the edges. That is, an operation O(log N)˜O(N) in which the information about a particular node is searched from all nodes (searched from a total number of nodes N) need not be performed.

However, consider a case in which there is a substantial increase in a number of edges M related to a particular node. In that case, the operation of searching an edge or searching a neighboring node from the particular node is 0(M). Thus, as compared to a case in which the number of edges M is small, the processing time (the calculation amount) for searching the information increases to a large extent. Hence, it is believed that reducing the number of edges M related to a particular node leads to an enhancement in the processing performance of the entire information processing device 100. In the following explanation, achieving reduction in the number of edges related to a node to a number smaller than a predetermined number and thus preventing excessive processing (excessive calculation amount) with respect to the data of the graph structure is referred to as optimization.

Given below is the detailed explanation of the operations performed in the information processing device 100. FIG. 2 is a flowchart for explaining an example of the operations performed in the information processing device 100. Firstly, from among the data of the graph structure stored in the first memory unit 10, the determining unit 18 starts an operation to search a candidate node (hereinafter, referred to as “a target node for optimization”) for which the data is to be subjected to data structure transformation before storing (step S100).

As a specific example, the determining unit 18 determines, on a node-by-node basis, whether or not the number of edges is exceeding a threshold value (step S102). Then, the determining unit 18 sets such a node as the target node for optimization for which the number of edges M is excessively large (for example, a node having the number of edges equal to or greater than the total number of nodes N) (a first determination criterion). With respect to a node that has the number of edges exceeding the threshold value (Yes at step S102), the determining unit 18 starts an operation at step S104. When a particular node has the number of edges equal to or smaller than the threshold value (No at step S102), the determining unit 18 performs the determination with respect to one of the remaining nodes.

Then, from the node for which the number of edges M is excessively large, the determining unit 18 starts an operation to search for the data that is to be subjected to data structure transformation before storing (i.e., to search for target data for transformation) (step S104).

For example, the determining unit 18 determines, on an edge-by-edge basis, whether or not the edge satisfies predetermined conditions (step S106). Then, the determining unit 18 sets such an edge as the target data for transformation that, for example, is accessed with the access frequency smaller than a threshold value (for example, accessed with the access frequency smaller than 1%) (a second determination criterion). Subsequently, with respect to the edge that is accessed with the access frequency smaller than the threshold value (Yes at step S106), the determining unit 18 starts an operation at step S108. When a particular edge is accessed with the access frequency equal to or greater than the threshold value (No at step S106), the determining unit 18 performs the determination with respect to one of the remaining edges.

Then, the transformation processing unit 160 transforms the data structure of each edge that is determined to be the target data for transformation and performs propertization (see FIG. 4); and reduces the number of edges of the target node for optimization (step S108).

Subsequently, in the second memory unit 12, the transformation processing unit 160 stores the data that has been subjected to data structure transformation and propertization (i.e., the data that has been transformed from having the graph structure to having the non-graph structure) (step S110).

In the example of the operations performed in the information processing device 100, the explanation is given for a case in which the target data for transformation of the target node for optimization is subjected to data structure transformation. However, the operations performed in the information processing device 100 are not limited to that case. Moreover, the data (edge) that is subjected to data structure transformation and then stored in the second memory unit 12 by the transformation processing unit 160 can either be deleted from the first memory unit 10 or be distinguished using a deletion mark so as to make it unsearchable (make it a non-edge). That is, in the information processing device 100, as a result of reducing the number of edges to be processed in the target node for optimization, it becomes possible to enhance the processing speed related to the target node for optimization. For example, if the number of edges of the target node for optimization decreases from 100 to 10, then the processing speed (the calculation amount) related to the target node for optimization decreases to 1/10-th of the previous processing speed.

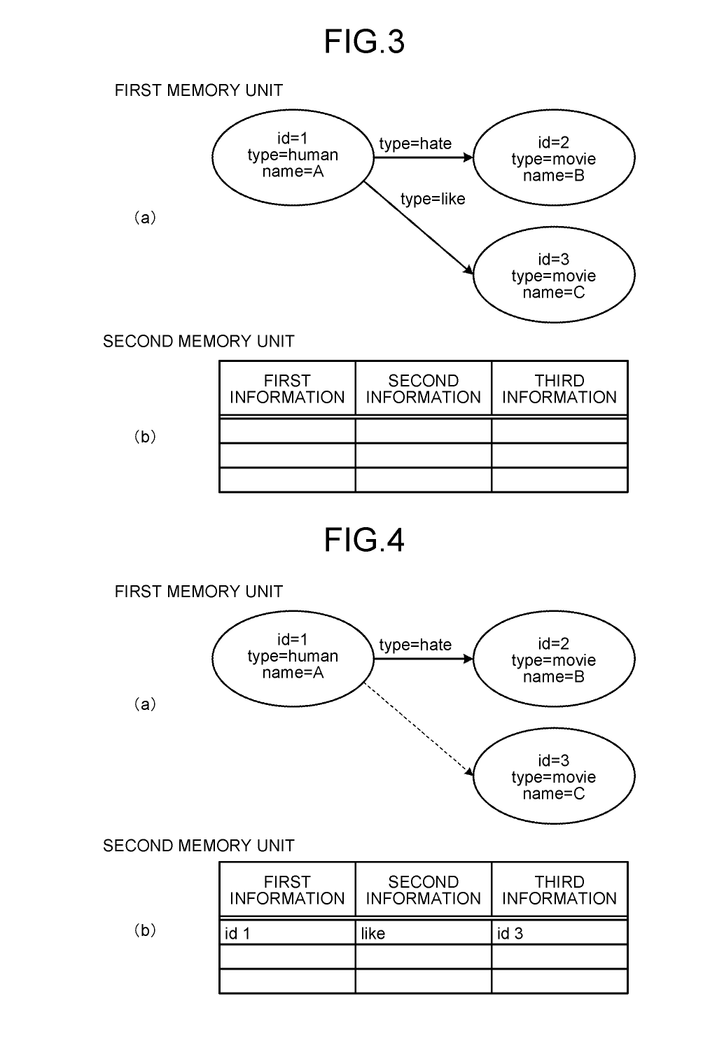

Given below is the detailed explanation of data structure transformation. FIG. 3 is a diagram illustrating exemplary data that has the graph structure and that is stored in the first memory unit 10, and illustrating an example of the non-graph structure of data stored in the second memory unit 12. In section (a) of FIG. 3 is illustrated an example of pre-optimization data that has the graph structure and that is stored in the first memory unit 10. In section (b) of FIG. 3 is illustrated an example of the non-graph structure of data stored in the second memory unit 12. Meanwhile, it is assumed that, in the information processing device 100, no data is stored in the second memory unit 12 prior to performing the optimization.

As illustrated in section (a) of FIG. 3, the data stored in the first memory unit 10 has the graph structure including, for example, three nodes, namely, a first node to a third node (id=1, 2, and 3, respectively) and two edges (type=hate and type=like). Herein, “id” of a node indicates the information (ID) that enables unique identification of a target node for optimization, and is considered to be first information. Moreover, information indicating “type” and “name” of an edge is considered to be second information. Furthermore, the information (ID) that enables unique identification of another node (an opposite node) that is linked to a target node for optimization via an edge, or name information in a readable form (for human beings) representing an opposite node is considered to be third information. Herein, for example, “person” indicates all nodes having an edge “type=human”.

For example, a query issued with respect to the data of the graph structure looks like “what is the title of the movie liked by a person A?”. If this query is applied to the data illustrated in FIG. 3A and is expressed in a precise sense, then the expression is “with respect to the node (id=1) of ‘type=human’ and having the name ‘A’, display name of the node (id=3) of ‘type=movie’ linked via the edge ‘type =like’”.

As illustrated in section (b) of FIG. 3, the second memory unit 12 stores the data made of the first information, the second information, and the third information as property structure (non-graph structure) data.

### FIRST EXAMPLE OF OPTIMIZATION

FIG. 4 is a diagram illustrating a first example of optimization (transformation) performed by the structure transforming unit 16 with respect to the data having the graph structure illustrated in FIG. 3. As illustrated in section (a) of FIG. 4, for example, the edge “type=like” is deleted from the first memory unit 10 due to optimization. Herein, an edge (or a node) illustrated using a dashed line indicates a deleted edge (or an edge that is not considered for processing as if it is deleted).

As illustrated in section (b) of FIG. 4, the second memory unit 12 stores therein the information of edges deleted from the first memory unit 10 (i.e., the information transformed by the transformation processing unit 160). Herein, the second memory unit 12 sets information (ID=id3), which enables unique identification of the opposite node, as the third information.

In the condition illustrated in FIG. 4, in the first memory unit 10, “a node linked to the node (id=1) via the edge ‘type=like’” is not present. Hence, using the same query as the query described above, it is not possible to obtain the same processing result as the pre-optimization processing result. For example, the third memory unit 14 is used to store the transformation processing information indicating that the edge “type=like” present in the second memory unit 12 is present in the second memory unit 12. As a result, with respect to the query, the data stored in the second memory unit 12 can be used to display that the third node (id=3) is the node liked by the first node (id=1) and to eventually display the “name” of the third node.

In this way, during the optimization performed in the information processing device 100, it is not just that the edges of the target node for optimization are deleted, but the information (data) of the deleted edges is stored in the second memory unit 12 with a different data structure from the graph structure. Hence, in the information processing device 100, even after the optimization is performed, the information (data) of the edges that are deleted from the first memory unit 10 can be used by reading them from the second memory unit 12.

### SECOND EXAMPLE OF OPTIMIZATION

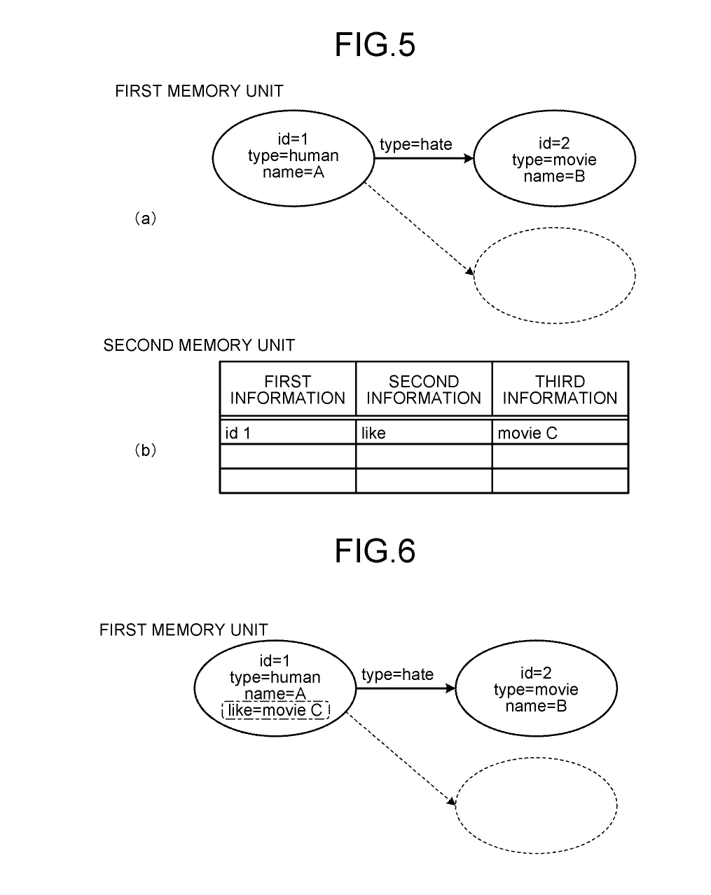

FIG. 5 is a diagram illustrating a second example of optimization (transformation) performed by the structure transforming unit 16 with respect to the data having the graph structure illustrated in FIG. 3. As illustrated in section (a) of FIG. 5, for example, the edge “type=link” and the third node (id=3) are deleted from the first memory unit 10. As illustrated in section (b) of FIG. 5, the second memory unit 12 is used to store the information deleted from the first memory unit 10 (i.e., the information transformed by the transformation processing unit 160). Herein, the second memory unit 12 considers, as the third information, the name information in a readable form (for human beings) representing an opposite node.

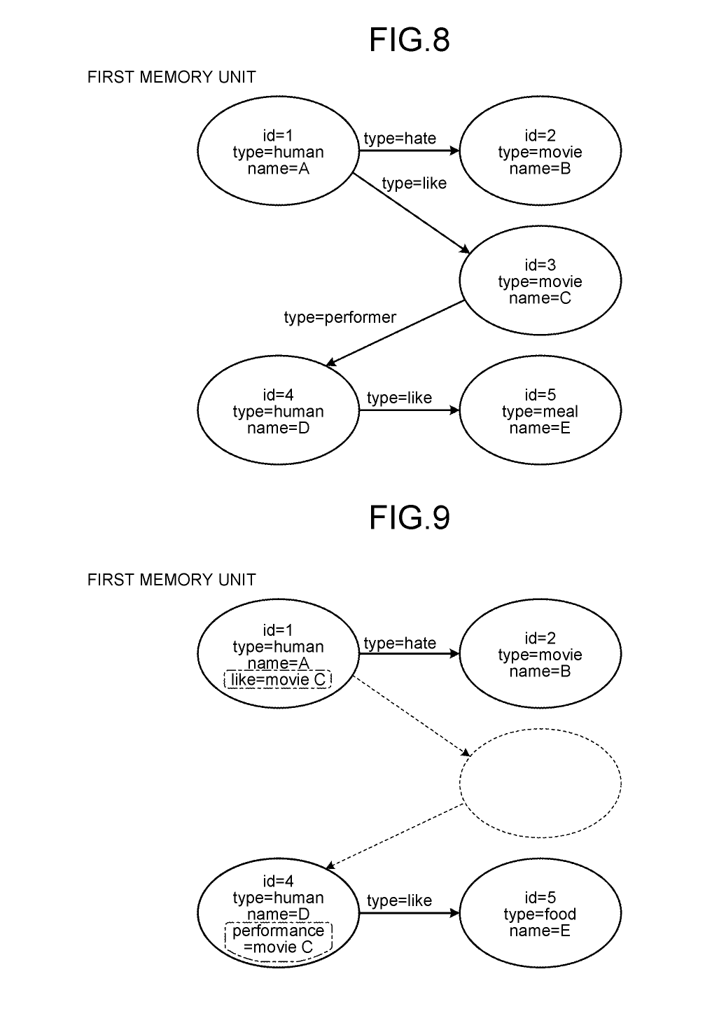

In the condition illustrated in FIG. 5 too, it is possible to obtain almost the same processing result as the condition illustrated in FIG. 4. However, since the information about the third node is expressed as the name information in a readable form for human beings, it is not possible to process a query that further tracks a node linked to the third node. For example, it is not possible to process a query such as “the food items liked by the person who is appearing in the movie liked by person A”. Thus, when the deleted third node is not a leaf node, there are times when the optimization illustrated in FIG. 5 leads to a problem. In that regard, the information processing device 100 further performs the operations explained later with reference to FIGS. 8 and 9.

### THIRD EXAMPLE OF OPTIMIZATION

FIG. 6 is a diagram illustrating a third example of optimization (transformation) performed by the structure transforming unit 16 with respect to the data having the graph structure illustrated in FIG. 3. As illustrated in FIG. 6, for example, the edge “type=link” and the third node (id=3) are deleted from the first memory unit 10. Moreover, in the third example of optimization, the information processing device 100 considers, as the third information, the name information in a readable form (for human beings) representing an opposite node, and stores the information of the deleted edge and the deleted node as the property (illustrated with an area enclosed by a dashed-dotted line) of the first node (id=1). Thus, in the third example of optimization, the property of the first node serves as an alternative for the second memory unit 12. In the condition illustrated in FIG. 6 too, it is possible to obtain almost the same processing result as the condition illustrated in FIG. 5. Meanwhile, when the deleted third node is not a leaf node, there are times when the optimization illustrated in FIG. 6 leads to a problem. In that regard, the information processing device 100 further performs the operations explained later with reference to FIGS. 8 and 9.

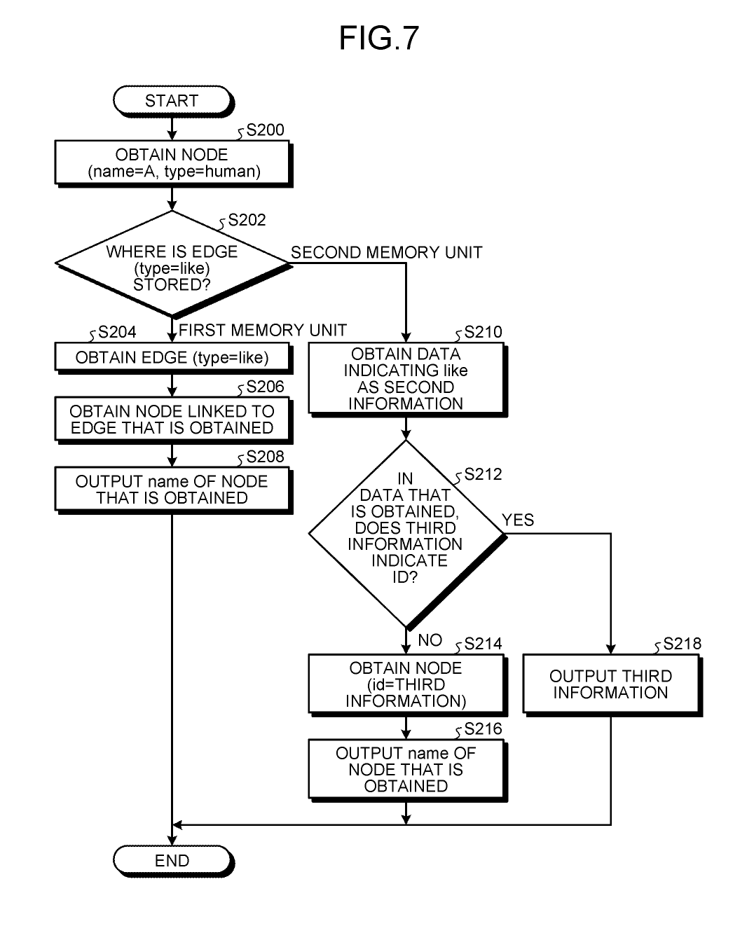

FIG. 7 is a flowchart for explaining an example of operations performed to process a query in the information processing device 100. As illustrated in FIG. 7, a CPU (not illustrated) obtains a node (name=A, type=human) (step S200).

Then, the CPU determines whether an edge (type=like) is stored in the first memory unit 10 or in the second memory unit 12 (step S202). If the edge (type=like) is stored in the first memory unit 10, then the system control proceeds to step S204. On the other hand, if the edge (type=like) is stored in the second memory unit 12, then the system control proceeds to step S210.

At step S204, the CPU obtains the edge (type=like) (step S204).

Then, the CPU obtains the node that is linked to the edge obtained at step S204 (step S206).

Subsequently, the CPU outputs the “name” of the node obtained at step S206 (step S208).

Then, from the second memory unit 12, the CPU obtains data indicating “like” as the second information (step S210).

Subsequently, the CPU determines whether or not the third information of the data obtained at step S210 indicates “ID” (step S212). If the third information of the data obtained at step S210 indicates “ID” (Yes at step S212), then the system control proceeds to step S214. On the other hand, if the third information of the data obtained at step S210 does not indicate “ID” (No at step S212), then the system control proceeds to step S218.

At step S214, the CPU obtains a node (id=third information) (step S214).

Subsequently, the CPU outputs the “name” of the node obtained at step S214 (step S216).

Then, the CPU outputs the third information (step S218).

Given below is the explanation about the operations performed in the information processing device 100 in the case when an opposite node is not a leaf node. FIG. 8 is a diagram illustrating the data of the graph structure stored in the first memory unit 10 (in the case when an opposite node is not a leaf node). As illustrated in FIG. 8, when an opposite node (the third node) is not a leaf node, the information processing device 100 performs, for example, either one of the following operations (a first exemplary operation to a third exemplary operation).

In the first exemplary operation, when an opposite node is not a leaf node, the information processing device 100 does not perform optimization (data structure transformation). In the second exemplary operation, when an opposite node is not a leaf node, the information processing device 100 performs optimization explained in the first example of optimization (FIG. 4) but does not perform optimization explained in the second example of optimization (FIG. 5) or the third example of optimization (FIG. 6). In the third exemplary operation, when an opposite node is not a leaf node, the information processing device 100 performs optimization by considering all other nodes linked to the opposite node (i.e., the opposite nodes of the opposite node) as the target nodes for optimization.

FIG. 9 is a diagram illustrating the third exemplary operation implemented in the information processing device 100 in the case when an opposite node is not a leaf node. As illustrated in FIG. 9, in the third exemplary operation, the information processing device 100 performs optimization by also considering a fourth node (id=4), which is linked to the opposite node (i.e., the deleted node: the node having id=3 illustrated in FIG. 8), as the target node for optimization. Herein, the information of the third node (id=3) and the two edges (type=like, type=performer) is stored as the property of the first node or the fourth node (illustrated with areas area enclosed by dashed-dotted lines).

However, in the third exemplary operation, it is not possible to process the abovementioned query “the food items liked by the person who is appearing in the movie liked by person A”. It is possible to create a new edge from the first node to the forth node with some property like “type=preferring movie's performer” (not illustrated), and process the abovementioned query by using it. On the other hand, regarding a query “the performance in which the person who likes a food item E appears” in which no further tracking from the third node is performed, it is possible to process the query.

In this way, in the information processing device 100, with respect to the data stored in the first memory unit 10, the transformation processing unit 160 transforms the data structure from the graph structure to the non-graph structure and stores the transformed data in the second memory unit 12. Hence, it becomes possible to prevent a decline in the processing speed.

Meanwhile, in the information processing device 100, it is also possible to perform inverse transformation of the data structure from the non-graph structure to the graph structure using the inverse transformation processing unit 162. For example, when the number of edges of a target node for optimization decreases to a satisfactory extent due to the effect of an updating operation, or when there is an increase in the access frequency of the data stored in the second memory unit 12; the inverse transformation processing unit 162 performs inverse transformation. That is, in such cases, the inverse transformation processing unit 162 transforms the data structure of the data stored in the second memory unit 12 from the non-graph structure to the graph structure (i.e., performs inverse transformation) and stores the inverse-transformed data in the first memory unit 10.

For example, in the condition illustrated in FIG. 4, in order to transform the data structure from the non-graph structure to the graph structure, the inverse transformation processing unit 162 creates an edge starting from the node indicated by the first information toward the node indicated by the third information that are stored in the second memory unit 12. Herein, the inverse transformation processing unit 162 uses the second information as the “type” and the “name” of the created edge.

Moreover, in the condition illustrated in FIG. 5 or in the condition illustrated in FIG. 6, in order to transform the data structure from the non-graph structure to the graph structure, the inverse transformation processing unit 162 firstly creates a node from the third information (i.e., uses the third information as the “type” and the “name” of that node). If a node having the same information is already present, then the inverse transformation processing unit 162 makes use of the existing node. Then, the inverse transformation processing unit 162 creates an edge starting from the node indicated by the first information toward the created node (or the existing node that is used), and uses the second information as the “type” and the “name” of the created edge.

Meanwhile, in the information processing device 100, instead of managing the edges of a target node for optimization with a list structure, the data structure can be transformed with the aim of managing the data using a tree structure (such as B-Tree) based on the IDs of edges or opposite nodes. More particularly, for example, according to a tree structure based on identification information that enables unique identification of the edges related to a node or enables unique identification of other nodes linked to the edges of a node, the first memory unit 10 is used to store data that has a graph structure which contains, as the node information of the node, a list of edges related to the node. As a result, in the information processing device 100, an edge or an opposite node having a particular ID can be searched at the calculation amount O(log M).

Meanwhile, an information processing program executed in the information processing device according to the embodiment can be recorded in the form of an installable or executable file in a computer-readable recording medium such as a compact disk read only memory (CD-ROM), a flexible disk (FD), a compact disk readable (CD-R), or a digital versatile disk (DVD); and can be provided as a computer program product.

Alternatively, the information processing program executed in the information processing device according to the embodiment can be saved as a downloadable file on a computer linked to the Internet or can be made available for distribution through a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a first memory unit configured to store therein data having a graph structure which contains, as node information of a node, a list of edges related to the node;
a second memory unit configured to store therein data which has a non-graph structure different from the graph structure and which represents a mutual relationship between data elements; and
a transformation processing unit configured to transform a data structure of the data stored in the first memory unit from the graph structure to the non-graph structure, and store the transformed data in the second memory unit.

2. The device according to claim 1, further comprising a determining unit configured to, based on a predetermined determination criterion, determine whether to store data in the graph structure or in the non-graph structure, wherein
when the determining unit determines that the data stored in the first memory unit is to be stored in the non-graph structure, the transformation processing unit transforms the data structure from the graph structure to the non-graph structure and stores the transformed data in the second memory unit.

3. The device according to claim 2, wherein the determining unit performs determination based on at least one of predetermined determination criteria that include a number of edges related to the node, an access frequency to an edge of the node, a calculation amount for searching an edge of the node, an elapsed time since the last access to an edge of the node, and whether or not another node linked to an edge of the node is a leaf node.

4. The device according to claim 2, further comprising an inverse transformation processing unit configured to, when the determining unit determines that the data stored in the second memory unit is to be stored in the graph structure, transform the data structure from the non-graph structure to the graph structure and store the transformed data in the first memory unit.

5. The device according to claim 1, further comprising a third memory unit configured to, with respect to the data stored in the first memory unit, store transformation processing information at least indicating that the transformation processing unit has transformed the data structure from the graph structure to the non-graph structure and has stored the transformed data in the second memory unit.

6. The device according to claim 2, wherein, every time the data stored in the first memory unit is updated, the determining unit performs determination according to a predetermined determination criterion.

7. The device according to claim 2, wherein the determining unit performs determination when instruction information indicating an instruction to start determination is received or performs determination at predetermined intervals.

8. The device according to claim 2, wherein the determining unit performs determination after a read query is executed with respect to the data stored in the first memory unit.

9. The device according to claim 1, wherein, according to a tree structure based on identification information for uniquely identifying edges related to the node or for uniquely identifying another node linked to an edge of the node, the first memory unit stores therein data that has a graph structure which contains, as node information of the node, a list of edges related to the node.

10. An information processing method implemented to make an information processing device store data, the information processing device including
a first memory unit configured to store therein data having a graph structure which contains, as node information of a node, a list of edges related to the node, and
a second memory unit configured to store therein data which has a non-graph structure different from the graph structure and which represents a mutual relationship between data elements,
the method comprising:
transforming a data structure of the data stored in the first memory unit from the graph structure to the non-graph structure; and
storing data, which has the data structure transformed from the graph structure to the non-graph structure, in the second memory unit.

11. A computer program product comprising a computer-readable medium containing an information processing program that makes an information processing device store data, the device including
a first memory unit configured to store therein data having a graph structure which contains, as node information of a node, a list of edges related to the node, and
a second memory unit configured to store therein data which has a non-graph structure different from the graph structure and which represents a mutual relationship between data elements,
wherein the information processing program, when executed by a computer causes the computer to execute:
transforming a data structure of the data stored in the first memory unit from the graph structure to the non-graph structure; and
storing data, which has the data structure transformed from the graph structure to the non-graph structure, in the second memory unit.
